(19) United States
(12) Patent Application Publication
(10) Pub. No.: US 2001/0025640 A1
(43) Pub. Date: Oct. 4, 2001

(54) Anaesthetic gas filter with an anaesthetic gas detector

(75) Inventor: Tom Pessala, Ostersundom (FI)

Correspondence Address: SCHIFF HARDIN & WAITE, 6600 SEARS TOWER, 233 S WACKER DR, CHICAGO, IL, 60606-6473, US

(73) Assignee: Siemens Elema AB

(21) Appl. No.: 09/818,696

(22) Filed: Mar. 27, 2001

(30) Foreign Application Priority Data
Apr. 4, 2000 (SE) 0001216-1

(51) Int. Cl. A62B 7/10; A62B 23/02

(52) U.S. Cl. 128/205.27

(57) ABSTRACT

An anaesthetic gas filter, devised for connection to an anaesthetic machine, for absorbing/adsorbing anaesthetic gas, allows the need for replacement to be determined without the leakage of any anaesthetic gas. for this purpose, the anaesthetic gas filter has an anaesthetic gas detector arranged in the filter. An early indication of the need to replace the filter is then provided.

### BACKGROUND OF THE INVENTION

1. Field of the Invention

The present invention relates to a filter for an anaesthetic gas.

2. Description of the Prior Art

The discussion herein employs the term “absorption of anaesthetic gas” and “absorbent” for the material which interacts with the anaesthetic gas. The corresponding effect and meaning also can be achieved with an adsorbent for adsorbing anaesthetic gas. Thus, the concept “absorption” in the description also includes ‘adsorption’ to prevent needless repetition.

U.S. Pat. No. 3,867,936 describes an anaesthetic gas filter, intended for connection to the expiratory branch of an anaesthetic machine, for absorbing anaesthetic gas. The amount of anaesthetic gas absorbed can be estimated by weighing the filter. The filter is replaced with a new one when the weight increase reaches a given level.

This method has several disadvantages. A scale must be present if weighing is to take place during filter use. If weighing is only performed between usages, the filter could become saturated during use, causing the leakage of anaesthetic gas.

European Application 284 227 describes an apparatus and a process for recovering anaesthetic gas. An anaesthetic gas filter is placed on the outlet branch for expired gas in order to adsorb the anaesthetic gas. The filter inlet is connected to an inlet line, and the filter outlet is connected to an outlet line. A shunt line runs parallel to the filter, and expired gas can pass either through the filter or through the shunt line depending on the setting of two valves. The filter is heated to prevent the condensation of water in the filter. A gas detector for anaesthetic gas is arranged downstream from the filter. The gas detector is connected to the anaesthetic machine. Detection of the presence of anaesthetic gas triggers an alarm on the anaesthetic machine to indicate that the filter is saturated and should be replaced. When a filter is replaced, the valves are reset to allow all gas to flow through the shunt line.

A major disadvantage of this design is that the alarm is not activated until anaesthetic gas has already begun leaking into the atmosphere. In addition, two valves must first be reset to direct anaesthetic gas through the shunt line past the inlet and outlet lines each time the filter is replaced. The connections for the inlet line and outlet line must then be released. In the corresponding manner, the new filter must be connected to two lines, whereupon the valves must be reset to allow gas to pass the filter again. This means that filter replacement takes a relatively long time during which anaesthetic gas flows continuously into the atmosphere.

### SUMMARY OF THE INVENTION

An object of the present invention is to provide an anaesthetic gas filter which solves the aforementioned problems, in whole or in part, associated with known anaesthetic gas filters.

This object is achieved in accordance with the invention in an anaesthetic gas filter having an active filter volume, which interacts with anaesthetic gas to ether absorb or adsorb the anaesthetic gas, and wherein an anaesthetic gas detector is disposed in the filter volume.

Arranging an anaesthetic gas detector in the filter provides the earliest possible indication that the filter is saturated and in need of replacement. Locating the detector in the filter also contributes to a simpler filter design employing only one connector to the anaesthetic machine (the other end of the filter can discharge residual gas directly into the atmosphere). This makes filter replacement much faster and radically reduces the amount of anaesthetic gas leaking into atmosphere each time a filter is replaced.

In one preferred embodiment, the filter according to the invention has a first absorption volume with a first absorbent and a second absorption volume with a second absorbent, separated by the anaesthetic gas detector. When the first absorbent is so saturated that leaking anaesthetic gas starts reaching the detector, a first indication is triggered showing that the filter's first absorbent is no longer absorbing/adsorbing anaesthetic gas. The second absorbent simultaneously begins absorbing the leaking anaesthetic gas. Thus, no anaesthetic gas escapes into the atmosphere, even when the filter is not replaced immediately.

The absorbents can advantageously be separately replaceable, the second absorbent then being usable for a longer time since it does not need to adsorb gas for long periods.

In order to completely avoid the escape of anaesthetic gas, the filter can be equipped with flow channels that carry gas past the corresponding absorption volume when any absorbent is replaced. If, for example, the first absorbent is replaced, all gas is carried straight to the second absorbent which then absorbs all the anaesthetic gas.

The anaesthetic gas detector can be formed by of an indicator material that reacts with anaesthetic gas by changing color or the like. The indicator material is placed in a visible position in the filter and provides a simple and distinct indication that the filter (or absorbent) is in need of replacement. This is particularly advantageous when anaesthetic machines are used at locations other than hospitals.

Alternatively, the anaesthetic gas detector can be a sensor devised to identify anaesthetic gas. Sensors of this kind usually generate a signal when anaesthetic gas is detected. The signal can either be sent to an alarm unit in the anaesthetic machine or to a signal lamp or the equivalent on the filter.

### DESCRIPTION OF THE DRAWINGS

FIGS. 1A and 1B show a first embodiment of the anaesthetic gas filter according to the invention in longitudinal section and cross section, respectively with FIG. 1B being taken line I-I of FIG. 1A.

FIGS. 2and 2B show the anaesthetic filter according to FIG. 1 during the replacement of absorbent, with FIG. 2B being taken along line II-II of FIG. 2A.

FIG. 3 shows a second embodiment of the anaesthetic gas filter according to the invention.

### DESCRIPTION OF THE PREFERRED EMBODIMENTS

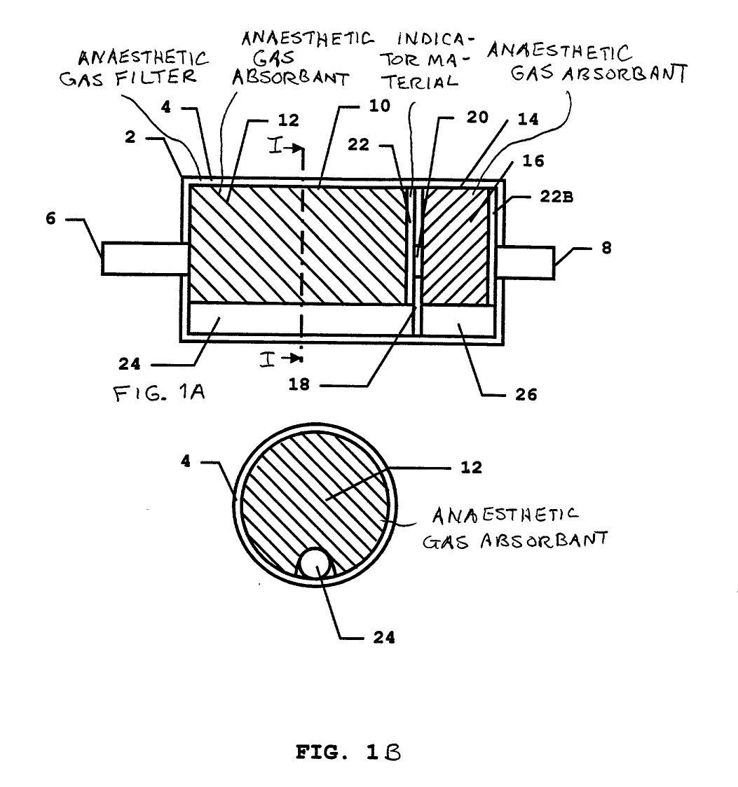

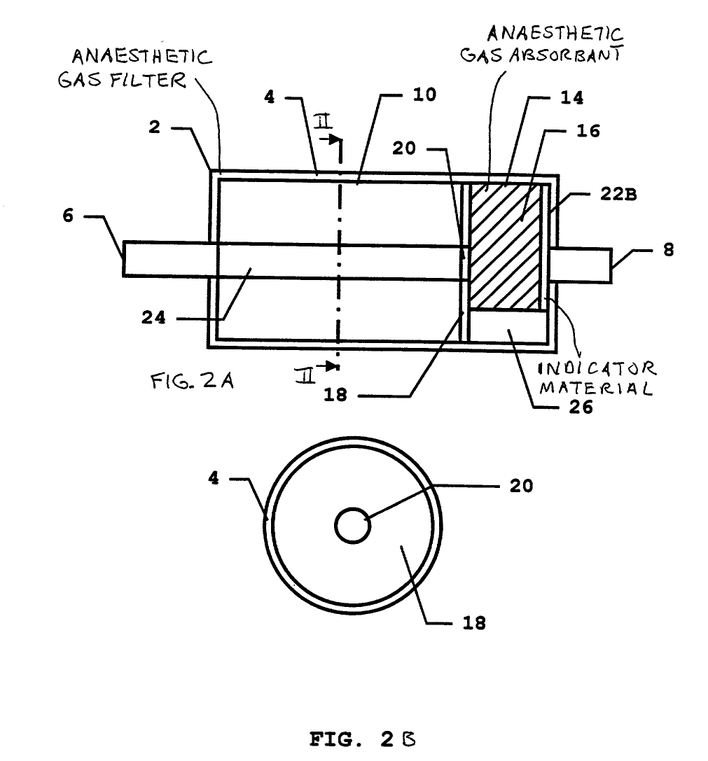

The following description generally applies to FIGS. 1A and 1B as well as to FIGS. 2A and 2B. An anaesthetic gas filter 2 has an enclosure 4, an inlet 6 and an outlet 8. The inlet 6 is devised for connection to an anaesthetic machine in order to receive expired gas. The outlet 8 can be open to the atmosphere or devised for connection to an evacuation line or the like.

Inside the enclosure 4, the filter 2 is divided into a first absorption volume 10, in which a first absorbent 12 is arranged, and a second absorption volume 14, in which a second absorbent 16 is arranged. A partition 18 separates the two absorption volumes 10, 14. A hole 20 in the partition 18 is arranged to allow the passage of gas.

An anaesthetic gas detector in the form of an indicator material 22 is arranged next to the first absorbent 12. The indicator material 22 is arranged so it is visible through the enclosure 4 and changes color when it comes into contact with anaesthetic gas.

When the indicator material 22 changes color, the first absorbent 12 is therefore deemed to be saturated and in need of replacement. The enclosure 4 is devised with hatches (not shown) providing access for replacement of absorbents 12, 16. The absorbents 12, 16 can advantageously have a gas-tight outer coating preventing gas from escaping through the hatches when the hatches are open.

When the first absorbent 12 is lifted out (as shown in FIGS. 2A and 2B), a first shunt line 24 automatically deploys and connects to the inlet 6 and the hole 20 in the partition 18. All gas then passes straight to the second absorption volume 14 and the second absorbent 16. Minimal leakage then occurs when the first absorbent 12 is replaced.

In the corresponding manner, a second shunt line 26 is arranged in the second absorption volume 14. When the second absorbent 16 is replaced, the second shunt line 26 automatically deploys to connect the hole 20 in the partition 18 to the outlet 8. The second shunt line 26 mainly functions when the outlet 8 is connected to an evacuation line or the equivalent. Additional indicator material 22B can be arranged after the second absorbent 16 to show when the second absorbent 16 needs to be replaced.

The shunt lines 24,26 can be spring-loaded or devised using some other known design in order to achieve automatic deployment. Alternatively, valves can be arranged to automatically switch the gas through shunt lines when an absorbent is lifted out of the filter.

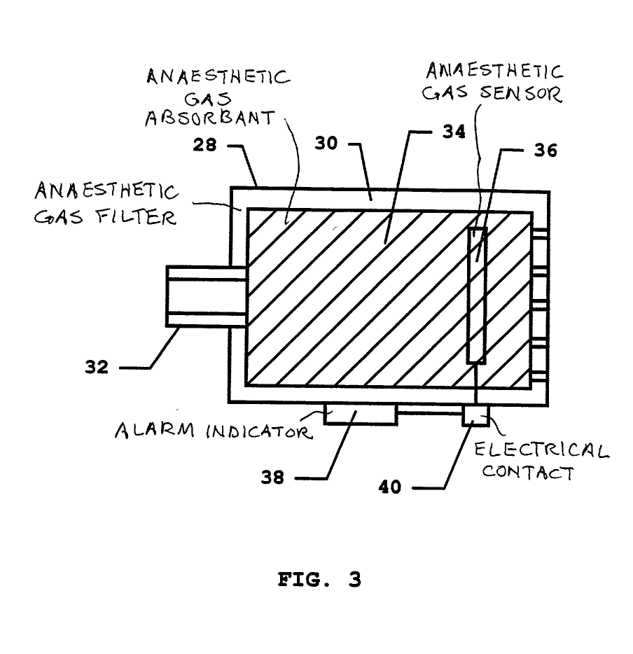

FIG. 3 shows a second embodiment of the anaesthetic gas filter according to the invention. The anaesthetic gas filter 28 has an enclosure 30 and an inlet 32 at one end for connection to an anaesthetic machine. The enclosure 30 is perforated at the other end to release unabsorbed gas into atmosphere.

An absorbent 34 is arranged in the enclosure to absorb anaesthetic gas. All known materials for absorbing anaesthetic gas can be used (individually or in various combinations). Activated charcoal and zeolites are just two examples of such materials.

An anaesthetic sensor 36 is arranged in the absorbent 34. The anaesthetic sensor 36 is advantageously placed close to the perforated part of the enclosure 30. When the anaesthetic gas sensor 36 senses the presence of anaesthetic, it generates a signal sent to an alarm indicator 38 on the enclosure 30. The alarm indicator 38 shows, with an optical signal, acoustic signal or both, that the filter needs replacement.

The anaesthetic sensor 36 and the alarm indicator 38 can be composed of simpler components which can be discarded with the filter. They can also be transferred to the next filter or reused in other filters (the enclosure 30 can also be reused).

The signal from the anaesthetic sensor 36 can also be sent to the anaesthetic machine or to some other equipment (not shown) through a contact 40 for a signal line (not shown).

The illustrated embodiments can be combined in different ways, For example, the anaesthetic gas filter according to the first embodiment can be devised with an anaesthetic sensor instead of indicator material (and vice-versa for the anaesthetic gas filter according to the second embodiment). The anaesthetic gas filter according to the first embodiment can also be devised with a perforated enclosure instead of a connectable outlet (and vice-versa for the anaesthetic gas filter according to the second embodiment). Other combinations are obviously possible.

Although modifications and changes may be suggested by those skilled in the art, it is the intention of the inventor to embody within the patent warranted hereon all changes and modifications as reasonably and properly come within the scope of his contribution to the art.

I claim as my invention:

1. An anaesthetic gas filter comprising:
an active filter volume for interacting with anaesthetic gas selected from the group consisting of a gas absorption volume and a gas adsorption volume; and
an anaesthetic gas detector disposed in said filter volume.

2. An anaesthetic gas filter as claimed in claim 1 wherein said filter volume comprises a first volume containing a first filter material and a second volume containing a second filter material, with said anaesthetic gas detector being disposed to separate said first and second volumes.

3. An anaesthetic gas filter as claimed in claim 2 wherein said first volume is accessible for replacing said first filter material and wherein said second volume is accessible for replacing said second filter material.

4. An anaesthetic gas filter as claimed in claim 3 further comprising flow channels for carrying gas passed one of said volumes when said one of said volume is being accessed for replacing the filter material therein.

5. An anaesthetic gas filter as claimed in claim 1 wherein said anaesthetic gas detector comprises indicator material which reacts with anaesthetic gas and which is visible from an exterior of said volume.

6. An anaesthetic gas filter as claimed in claim 1 wherein said anaesthetic gas detector is a sensor which identifies a presence of anaesthetic gas.
